(19) United States
(12) Patent Application Publication
(10) Pub. No.: US 2024/0361541 A1
(43) Pub. Date: Oct. 31, 2024

(54) APPARATUS AND METHODS FOR OPTICAL ALIGNMENT FOR PHOTONIC INTEGRATED CIRCUITS

(71) Applicant: Intel Corporation, Santa Clara, CA (US)

(72) Inventors: Alexander Krichevsky, Cupertino, CA (US); Boping Xie, San Ramon, CA (US); Sunil Priyadarshi, San Jose, CA (US); Chao Tian, Bozeman, MT (US); Guojiang Hu, San Jose, CA (US); Hari Mahalingam, San Jose, CA (US); Haijiang Yu, San Jose, CA (US)

(73) Assignee: Intel Corporation, Santa Clara, CA (US)

(21) Appl. No.: 18/309,123

(22) Filed: Apr. 28, 2023

(51) Int. Cl. G02B 6/42

(52) U.S. Cl. CPC G02B 6/4206; G02B 6/42; G02B 6/4214

(57) ABSTRACT

Method and apparatus for vision assisted optical alignment. In the apparatus, one or more main waveguides of a photonic integrated circuit (PIC) are selected, and respective one or more corresponding auxiliary waveguides are terminated with a respective scattering structure. The scattering structures deflect externally supplied light out of the PIC for detection by a camera or photo detector to provide feedback on the amount of light coupled into the main waveguides during the optical alignment process. The method and apparatus eliminate the need to power up the PIC circuitry, speed up the subsequent alignment process, and allow control and failure analysis of multiple channels at once.

### BACKGROUND

Many multi-die assemblies implement a photonic integrated circuit (PIC) that is to communicate with an external optical component. In support of this, various passive and active optical alignment approaches have been developed to assure or optimize alignment efficiency. However, continued improvements to alignment approaches are desired.

### BRIEF DESCRIPTION OF THE DRAWINGS

FIGS. 1A-1B are simplified views of a system including a photonic integrated circuit (PIC) die with an apparatus for optical alignment, in accordance with various embodiments.

FIG. 2A is a simplified view of an embodiment of the system of FIG. 1A.

FIG. 2B is a simplified view of an embodiment of the system of FIG. 1A.

FIG. 3A is a simplified view of an embodiment of the system of FIG. 1A.

FIG. 3B is a simplified view of an embodiment of the system of FIG. 1A.

FIG. 4 provides some non-limiting examples of embodiments of light scattering structures.

FIG. 5 illustrates an exemplary method for using provided embodiments to perform visual optical alignment.

FIG. 6 is a simplified cross-sectional side view of a multi-chip package that includes a photonic integrated circuit (PIC) with an apparatus for optical alignment, in accordance with various embodiments.

FIG. 7 is a top view of a wafer and dies that may be included in a microelectronic assembly, in accordance with any of the embodiments disclosed herein.

FIG. 8 is a simplified cross-sectional side view showing an implementation of an integrated circuit on a die that may be included in various embodiments, in accordance with any of the embodiments disclosed herein.

FIG. 9 is a cross-sectional side view of a microelectronic assembly that may include any of the embodiments disclosed herein.

FIG. 10 is a block diagram of an example electrical device that may include any of the embodiments disclosed herein.

### DETAILED DESCRIPTION

The following detailed description is merely exemplary in nature and is not intended to limit the application and uses. It may be evident that the novel embodiments can be practiced without every detail described herein. For the sake of brevity, well known structures and devices may be shown in block diagram form to facilitate a description thereof.

In various embodiments, a photonic integrated circuit (PIC) may be located next to an electronic integrated circuit (EIC), and/or be part of a multi-die assembly or multi-die stack. External optical components, such as a fiber array unit (FAU) may be placed in connection with the PIC. Ensuring a robust interface (i.e., optimized optical alignment) for optical communication between the PIC and the external optical component is a technical problem to solve.

Some solutions to this technical problem are passive alignment schemes. One example of a passive alignment scheme being developed utilizes a lithography process to create a precision v-groove feature to locate fibers therein; another implements an optical wire (vision based passive placement); still another implements an in-situ laser write optical waveguide etc. However, passive alignment has no optical performance feedback and often relies on meeting tight manufacturing and assembly tolerances by all sub-components to achieve an acceptable optical coupling efficiency. Since the tolerances of the various sub-components stack up, passive alignment schemes are often sub-optimum. Additionally, some optical components, like waveguides and etched features, are relatively easy to place in a planar direction using lithography features and vision-based alignment, they can be difficult to place in a vertical dimension. Other optical components, like lenses and focusing mirrors, can be notoriously difficult to place precisely since a sub-micron precision is typically required, and precision fiducials for 3D alignment are difficult to obtain. Performance of all these approaches is limited by component tolerance and placement or vision accuracies. It is challenging for passive alignment schemes to be competitive with active alignment schemes on either coupling efficiency or on cost in the short term (due to relying on equipment for a remarkably high precision pick and placement or in-sit processing).

Other solutions include active alignment schemes. Typical active alignment schemes require powering up the silicon photonics integrated circuit (PIC). In scenarios using a transmitter, then measuring the light power coupled into outgoing fiber(s) using photodiodes and establishing a feedback loop between coupled power and an optical component (such as a lens) holder position. When more than one optical component is being aligned (such as a number of waveguides aligned with an array of fibers in a fiber block, using a single-piece lens array), the lasers at the source may need to be switched on and off and/or a number of output channels must be analyzed at the same time to obtain the needed information for optimizing alignment. The fiber block referred to herein may hold the optical fibers only, or it may be butt-coupled to a Planar Light Circuitry (PLC) composed of an array of waveguides. Active alignment can realize an exceptionally reliable optimum optical coupling as compared to passive alignment, but it is time consuming, requires complicated handling and setup in order to power on the PIC sub-assembly, and is generally expensive. Accordingly, it is desirable to provide improved optical alignment methods and apparatus.

The present disclosure provides a technical solution to the above-described problems related to optical alignment and provides an improvement over the limitations of available solutions, in the form of an apparatus for optical alignment which is an active alignment that approaches passive alignment schemes in speed and cost. In aspects of the present disclosure, the main waveguides (to achieve best result, the two outer most main waveguides are preferred) of a PIC are tapped, and corresponding through auxiliary waveguides are terminated with a respective scattering structure. The scattering structures are used to deflect the light towards a camera or photo detector to provide feedback on the amount of light coupled into the main waveguides during the optical alignment process. Therefore, the output from the scattering structures provides direct feedback on the optical coupling performance, eliminating the need to power up the PIC circuitry. The apparatus for optical alignment, its implementation in a PIC die, and an exemplary method for its use is described in more detail in connection with the figures below.

Exemplary embodiments will hereinafter be described in conjunction with the following drawing figures, wherein like numerals denote like elements. Figures are not necessarily to scale but may be relied on for spatial orientation and relative positioning of features. As may be appreciated, certain terminology, such as “ceiling” and “floor”, as well as “upper,”, “uppermost”, “lower,” “above,” “below,” “bottom,” and “top” refer to directions based on viewing the Figures to which reference is made. Further, terms such as “front,” “back,” “rear,”, “side”, “vertical”, and “horizontal” may describe the orientation and/or location of portions of the component within a consistent but arbitrary frame of reference which is made clear by reference to the text and the associated Figures describing the component under discussion. Such terminology may include the words specifically mentioned above, derivatives thereof, and words of similar import.

As used herein, the term “adjacent” refers to layers or components that are in direct physical contact with each other, with no layers or components in between them. For example, a layer X that is adjacent to a layer Y refers to a layer that is in direct physical contact with layer Y. In contrast, as used herein, the phrase(s) “located on” (in the alternative, “located under,” “located above/over,” or “located next to,” in the context of a first layer or component located on a second layer or component) includes (i) configurations in which the first layer or component is directly physically attached to the second layer (i.e., adjacent), and (ii) component and configurations in which the first layer or component is attached (e.g. coupled) to the second layer or component via one or more intervening layers or components.

The term “overlaid” (past participle of “overlay”) may be used to refer to a layer to describe a location and orientation for the layer but does not imply a method for achieving the location and orientation. For example, a first layer overlaid on a second layer, or overlaid on a component means that the first layer is spread across or superimposed on the second layer or component. Accordingly, a layer that is overlaid on a second layer may be viewed in a cross-sectional view as adjacent to the second layer.

As used herein, the term “electronic component” can refer to an active electronic circuit (e.g., processing unit, memory, storage device, FET) or a passive electronic circuit (e.g., resistor, inductor, capacitor).

As used herein, the term “integrated circuit component” can refer to an electronic component configured on a semiconducting material to perform a function. An integrated circuit (IC) component can comprise one or more of any computing system components described or referenced herein or any other computing system component, such as a processor unit (e.g., system-on-a-chip (SoC), processor core, graphics processor unit (GPU), accelerator, chipset processor), I/O controller, memory, or network interface controller, and can comprise one or more additional active or passive devices such as capacitors, decoupling capacitors, resistors, inductors, fuses, diodes, transformers, sensors, electrostatic discharge (ESD) devices, and memory devices.

A non-limiting example of an unpackaged integrated circuit component includes a single monolithic integrated circuit die (shortened herein to “die”); the die may include solder bumps attached to contacts on the die. When present on the die, the solder bumps or other conductive contacts can enable the die to be directly attached to a printed circuit board (PCB).

A non-limiting example of a packaged integrated circuit component comprises one or more integrated circuit dies mounted on a package substrate with the integrated circuit dies and package substrate encapsulated in a casing material, such as a metal, plastic, glass, or ceramic. Often the casing includes an integrated heat spreader (IHS); the packaged integrated circuit component often has bumps or leads attached to the package substrate for attaching the packaged integrated circuit component to a printed circuit board or motherboard.

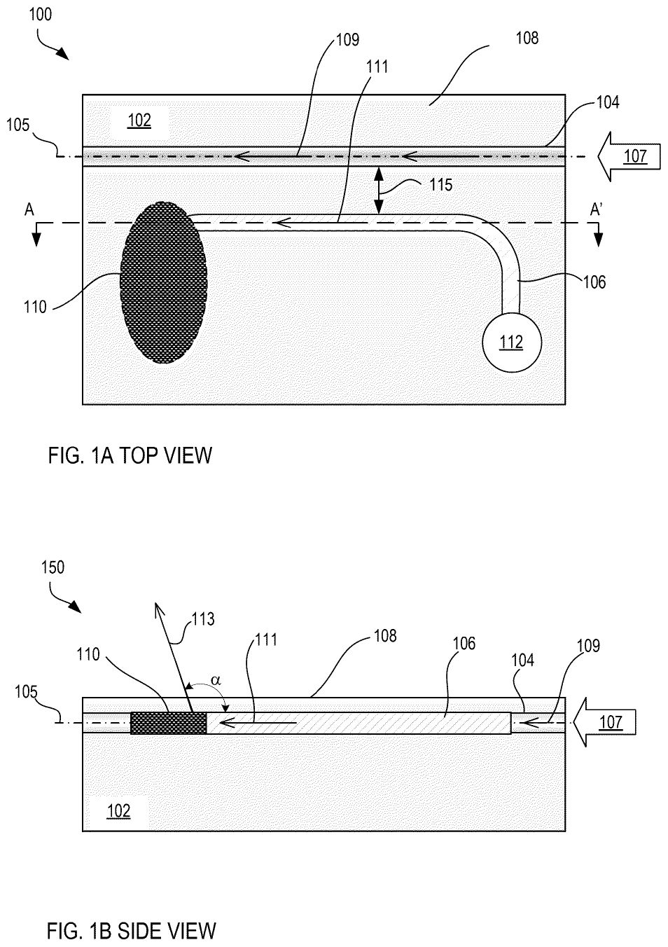

FIGS. 1A-1B are views of a system including a photonic integrated circuit (PIC) die with an apparatus for optical alignment (shortened herein to “system”), in accordance with various embodiments. FIG. 1A is a top-down view 100 and FIG. 1B is a side view. Embodiments of the system are characterized by the geometry and spatial relationships described herein.

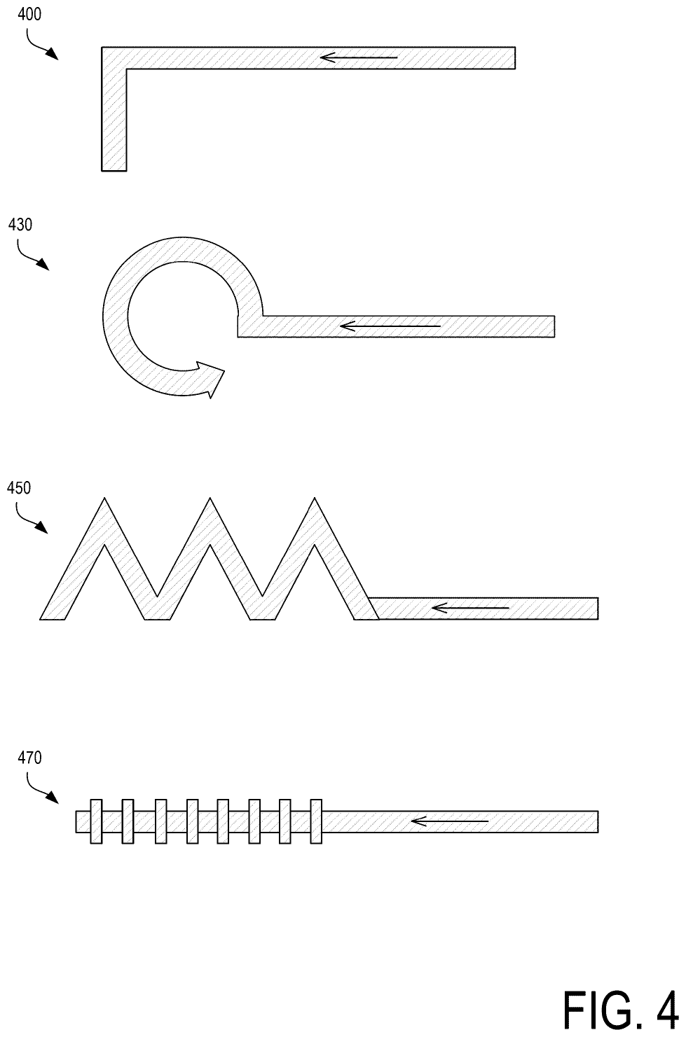

A photonic integrated circuit (PIC) die 102 includes or more optical channels or main waveguides 104. Many PICS have a plurality of main waveguides 104. For at least a portion of the PIC 102 that is to connect main waveguides 104 to external optical components (in the figures, this is indicated on the right side by the arrow representing light 107), the main waveguides 104 extend substantially within (or, just underneath) a top surface of the PIC die 102. As used here, substantially means+/−5%. At least one of the main waveguides 104 has an auxiliary waveguide 106 located near it (alternately stated, alongside it, or in close proximity), as shown, wherein the distance 115, may vary with applications, but is constrained to a magnitude that is sufficient to couple light from the main waveguide 104 to the auxiliary waveguide 106. Although illustrated as substantially parallel, those with skill in the art will appreciate that the main waveguide 104 and the auxiliary waveguide 106 need only to achieve the close proximity (distance 115) sufficient for the optical coupling purpose described herein; moreover, aspects of the auxiliary waveguides 106 may be curved (this concept is again mentioned in connection with FIG. 4, below). In many PICS, every main waveguide 104 has a respective auxiliary waveguide 106 similarly located alongside it. Individual of the auxiliary waveguides 106 are weakly (optically) coupled to a respective main waveguide 104 to direct light to a respective monitor photodiode 112 (PD). The photodiode 112 may be located at a terminus of the auxiliary waveguide 106, as shown. Available alignment solutions not having the apparatus of the present disclosure have the opposite terminus of the auxiliary waveguide 106 open or unterminated.

Proposed embodiments implement a light scattering structure 110 on one or more existing auxiliary waveguides 106, away from the PD photodiode 112. As used here, “on” means that the scattering structure 110 is in optical communication with the auxiliary waveguide 106, and “away” means that the scattering structure 110 is located in a region of space that is found at the previously unterminated terminal of the auxiliary waveguide 106, as illustrated. Depending upon the method of fabrication of the scattering structure 110, the scattering structure 110 may be an addition to the auxiliary waveguide 106 or may be a modification to/on the auxiliary waveguide 106.

As described hereinbelow, the FIG. 1B is a cross-sectional view 150 corresponding to a first cut A-A′ medially through an auxiliary waveguide 106. In various embodiments, the auxiliary waveguide 106 and main waveguide 104 are substantially coplanar for at least a portion of their extent, and a lateral centerline 105 indicates a centerline of the main waveguide 104. The views in FIG. 1A and FIG. 1B are simplified to just one main waveguide 104 and just one auxiliary waveguide 106 for development of concepts and relationships between these two components. Those with skill in the art will recognize that the concepts can be scaled to two or more or a plurality of respective main waveguides 104 and auxiliary waveguides 106.

Light 107 applied in a reverse direction (i.e., reverse of that which it travels when the PIC is powered and in operation) is indicated by the arrow. Responsive to the input of light 107, the light 109 traveling through main waveguide 104 is coupled to the auxiliary waveguide 106, causing light 111 the auxiliary waveguide 106 to impinge on the scattering structure 110 that deflects light (deflected light 113) out of the PIC 102. Deflected light 113 may be at an angle alpha with respect to a top surface 108 of the PIC die 102.

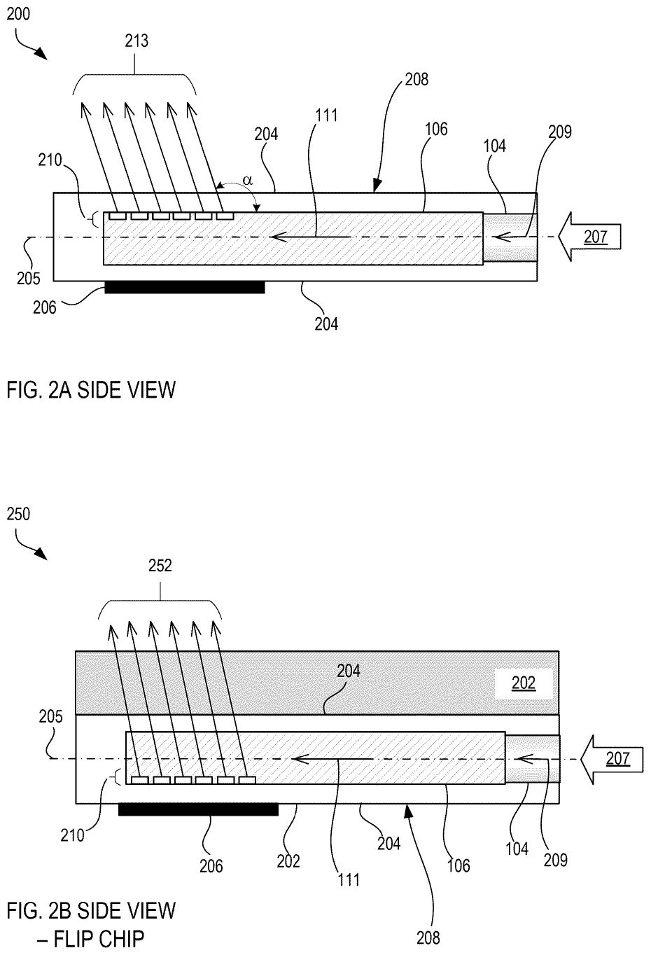

The light scattering structure may also be viewed as a means for scattering light. FIG. 2A and FIG. 2B illustrate the light scattering structure 110 (shortened herein to “scattering structure”) embodied as a diffraction grating. The photonic integrated circuit (PIC) die 102 may comprise a transparent dielectric material 204 (also referred to herein as “cladding” 204) overlaid on a substrate or wafer, and the waveguides (104, 106) may be located in this transparent dielectric material 204. Light applied at 207 enters main waveguide 106 (as light 209) and is coupled to the auxiliary waveguide 106 (as light 111). Light 111 impinges on the light scattering structure 210 and deflects light (deflected light 213) out of the PIC die 102. Deflected light 213 may be at an angle alpha with respect to the top surface 208 of the PIC die 102. Angle alpha may range from about 30 degrees to about 160 degrees. In some scenarios, angle alpha is about 90 degrees.

The cladding 204 can be any material with index of refraction lower than that of the PIC die 102 substrate or core. For relatively low-index optical fibers, cladding 204 may be Silicon Oxide. For very high-index Silicon waveguides (Index of Refraction ˜3.5) the cladding 204 can be a variety of non-Silicon materials, such as, but not limited to, Air (n=1), SiO2 (n=1.44), SiN (N=2), Diamond (n=2.4), SiC (n=2.55), and the like.

In FIG. 2A and FIG. 2B, the light scattering structure 210 comprises a diffraction grating in a periphery or an upper surface of the auxiliary waveguide 106, where “upper surface” is associated with the top surface 208 of the PIC die, as shown. The auxiliary waveguide 106 has a lateral centerline 205, from which the angle alpha can also be measured for the deflected light 213 in view 200 and deflected light 252 in view 250. In an embodiment, the diffraction grating comprises a plurality of cavities interrupting a surface of the auxiliary waveguide, the plurality of cavities being substantially parallel to one another and extending perpendicularly inward from the periphery or upper surface of the auxiliary waveguide 106, as indicated. Said differently, individual cavities of the plurality of cavities extend toward the lateral centerline 205 of the auxiliary waveguide 106. In various embodiments, individual cavities of the plurality of cavities have dimensions of substantially 10 microns deep by substantially 30 microns in length. In various embodiments, the cavities are etched into the auxiliary waveguide 106.

FIG. 2B illustrates a flip chip view 250, in which top surface 208 is at the bottom of the page. In the flip chip orientation, a substrate layer 202 may be overlaid or deposited on the bottom surface of the transparent dielectric material 204 (which appears to be the top in the illustration of view 250).

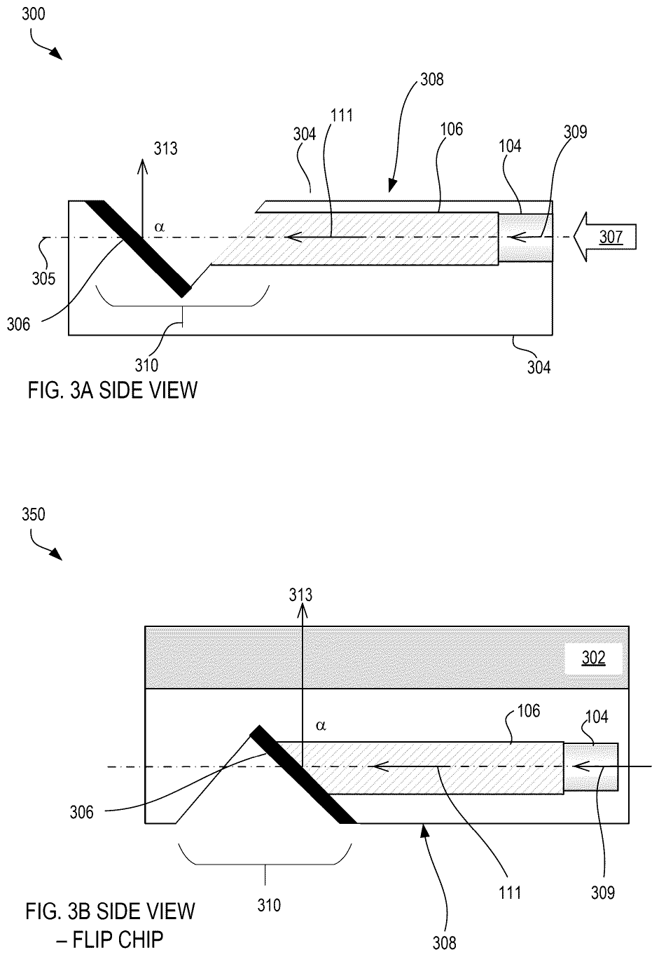

Various aspects of the disclosure further comprise an optional means for reflecting light, e.g., optional mirror 206 layer (and FIG. 3, optional mirror 306 layer) oriented to assist/boost the deflection of light from the light scattering structure (110, 210, and FIG. 3, scattering structure as v-groove 310) out of the PIC die. When present, the optional means for reflecting light (e.g., optional mirror 206) is to improve (e.g., substantially double) the efficiency of the scattering structure. The optional mirror 206 may comprise of a metallic material, and may be deposited on the surface of the PIC die. In some embodiments, the optional mirror may comprise gold or aluminum.

In FIG. 2A, mirror 206 is located on the bottom surface of the transparent dielectric material 204 and PIC die to deflect light (deflected light 213) from the scattering structure out of the top surface 208 of the PIC die. In the flip chip view 250 of FIG. 2B, a substrate layer 202 is located on a bottom surface of the PIC die and the mirror is located on the top surface 208 of the PIC die to deflect light (deflected light 252) from the scattering structure 210 out of the bottom surface of the PIC die and through the substrate layer 202, as shown.

For example, when the light 111 in the auxiliary waveguide 106 is affected by periodic perturbations of a diffraction grating, the diffracted light propagates equally at +/−a diffraction angle (those with skill in the art will appreciate that there are different angles for different orders of diffraction, but typically the first order of diffraction is the strongest). Therefore, to detect the beam of light from above, a metallic mirror can be deposited below the travel path of the beam of light, likewise, to detect the beam of light from below (i.e., through the chip) the metallic mirror can be deposited on a top surface. Optionally, some embodiments have enough light energy in the beam of light, and a lithography step (mirror deposition) can be saved/omitted, which corresponds to allowing half of the light energy to go to waste.

Some embodiments of the scattering structure 110 may be created using available v-groove etching techniques mentioned above. FIG. 3A and FIG. 3B provide simplified illustrations in which the scattering structure 110 is embodied as a v-groove 310. The v-groove 310 extends from the top surface 308, where it has the widest opening in the surface of the PIC die, into the PIC die, extending in depth to an apex/point (where the v-groove is narrowest) located past a lower periphery of the auxiliary waveguide 106, as shown. The v-groove 310 has a lateral centerline (that would extend out of the page) which is oriented substantially perpendicular to the lateral centerline 305 of the auxiliary waveguide 106. Externally applied light 307 is applied to the main waveguide 104, as shown.

In view 300, optional mirror 306 layer is deposited and positioned to boost the deflected light 313 at angle alpha upward through the top surface 308. In flip-chip view 350, the mirror 306 layer is positioned to boost deflected light 313 at angle alpha through the bottom surface of the PIC die and through the substrate layer 302.

As mentioned above, in practice, embodiments of the auxiliary waveguide 106 and of the scattering structure 110 are likely to have rounded corners and appear more irregular, like a hand-drawing, as opposed to comprising perfect curves, lines, and angles shown in the figures. As those with skill in the art will appreciate, the irregularities reflect the etching techniques and specific materials employed. The above-described embodiments of the scattering structure 110 are non-limiting. Other suggested embodiments are illustrated in FIG. 4. Again, FIG. 4 represents idealized shapes, wherein, in practice, the components would likely not have sharp corners and edges. FIG. 4 provides top view plans, and illustrates: a scattering structure fabricated as a bend (400) in or added to the auxiliary waveguide of about 90 degrees; a scattering structure 110 fabricated as a spiral (430) in or added to the auxiliary waveguide; a scattering structure 110 fabricated as a zig zag (450) in or added to the auxiliary waveguide; and, a scattering structure 110 fabricated with periodic edge defects (470) added to the auxiliary waveguide, which can also be referred to as an “in-plane” grating on the auxiliary waveguide.

In an exemplary method for making the above-described apparatus, the following tasks may be performed. A scattering structure may be formed at an unconnected terminus of an auxiliary waveguide 106 in a photonic integrated circuit (PIC) die using selective etching, wherein the auxiliary waveguide 106 is one of one or more auxiliary waveguides in the PIC die, the one or more auxiliary waveguides to couple light from a respective one or more main waveguides 104 in the PIC die to respective photodiodes. A mirror may be formed on a first surface of the PIC die, and a substrate layer may be overlaid on a second surface, or opposite surface of the PIC die from the mirror, such that the mirror reflects light, and the combined mirror and scattering structure are to deflect light through the substrate layer.

Cladding (204, 304) was described above. In some embodiments, the transparent dielectric material or cladding (204, 304) is a layer comprising oxygen and may include silicon dioxide. The substrate layer (202, 302) or core of the PIC die 102 may be about 50-250 microns thick (wherein “about” means plus or minus 10%). In practice, it may be difficult to distinguish the transparent dielectric material from the substrate layer in a cross-sectional scanning electron microscopy image (SEM), however, a non-limiting way to identify the described embodiments is to visually inspect both the materials present in a top down and/or cross-sectional view and the structure and shape of the materials to determine that the described embodiments have been implemented. Detecting embodiments may be as simple as opening a unit housing, as the diffraction gratings should be visible to the naked eye. A loupe or a low-power microscope would also show the presence of auxiliary waveguides.

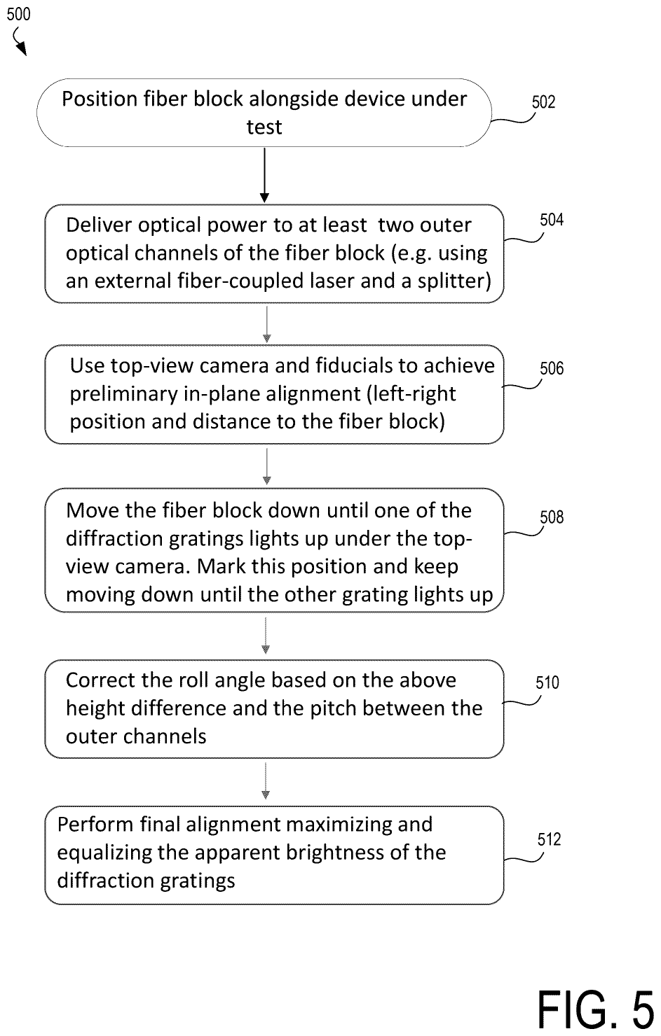

As initially mentioned, an intended use of the provided embodiments is to enable vision assisted semi-passive optical alignment. In FIG. 5, a method 500 for performing vision assisted semi-passive optical alignment using the embodiments is described. The method includes having a source of optical power and a top view camera.

At 502, a fiber block can be positioned alongside a device under test (DUT), wherein the DUT is a PIC die having therein an apparatus for optical alignment for photonic integrated circuits, as described above. The fiber block has a fiber array of optical channels configured to meet up with the main waveguides of the DUT, either with a direct abutment of components, or via optical isolators and lenses placed in between them.

At 504, optical power is delivered to at least two outer channels of the fiber block, the two outer channels of the fiber block correspond to two outer main waveguides 104 of the DUT. The application of optical power translates to the input of light 107 described above. Note that the wavelength of the light used for the alignment may be chosen to be different from the wavelength the chip is designed for. For instance, the chip is operated around 1300 nm, Near Infrared (NIR) light, which is invisible for vast majority of commercially used cameras. Red light may be used instead for alignment.

Note that although the proposed alignment procedure is based on actual amount of light coupled into the main waveguides (meaning that this is an active alignment method), the PIC itself is not powered and the photodiode signal is never read and analyzed.

At 506, using the top-view camera and fiducials, a preliminary in-plane alignment can be determined for the fiber block.

At 508, responsive to light 107, deflected light (optical feedback) from a first scattering structure is detected by the camera. This fiber block position can be marked or recorded, and the fiber block can be moved and positioned again until light from a second scattering structure is detected. The optical feedback can be registered by a camera which may utilize well-established and fast vision recognition methods to measure the brightness of the output spots at the sensor. This information can be used in turn to control the translation stages moving a FAU-holder to maximize the output brightness. In other words, this active alignment method may be as fast and efficient as passive alignment while utilizing optical feedback.

At 510 using the information from the first position and second position, a roll angle and pitch can be corrected to ensure the optical alignment. At 512, any further adjustments can be made to maximize the deflected light from the two scattering structures can be achieved.

The alignment criterion is based on the visually observed brightness of the scattering structure(s) as described herein, or more traditionally upon optical power detection. During the alignment process, the DUT or more specifically, the PIC, is not powered and it is not required to read or analyze photodiode output, effectively eliminating a complicated power-on setup and handling. If an array of fibers is to be aligned to an array of the main waveguides, at least two scattering structures may be needed. The wavelength of light used for alignment may be chosen to be visible by commonly used silicon-sensor cameras, further reducing the cost. Another advantage is that the added scattering structure is compatible with wafer-level test and flip chip processes.

This alignment approach, using the disclosed apparatus and methods, is particularly beneficial for pluggable products, in which an optical isolator is needed to reduce a harmful back-reflection into the source laser. Due to what is typically an extreme space constraint, the isolator often needs to be placed near the PIC for a reduced footprint and for better isolation. However, this requirement makes butt-coupling or evanescent coupling (which most of the passive alignment methods are based upon) not feasible anymore. It is also not practical to use an in-line isolator cable due to the physical space limitation, unlike Optical Compute Interconnect (OPI) and switch co-packaging cases. For these reasons, the provided apparatus and alignment approach is advantageous for pluggable products.

Accordingly, various non-limiting embodiments of a PIC die having therein an apparatus for optical alignment for photonic integrated circuits, and methods for making and using same have been provided. The provided embodiments advantageously employ a vision assisted direct optical feedback to optimize a coupling performance between a PIC component and an external optical component without having to power on a transmitter or receiver sub-assembly (TOSA or ROSA) in the PIC circuitry. Thus, embodiments achieve an optimum optical coupling with a much simplified “passive” optical alignment process.

In the following description and figures, additional context for the embodiments described above is provided.

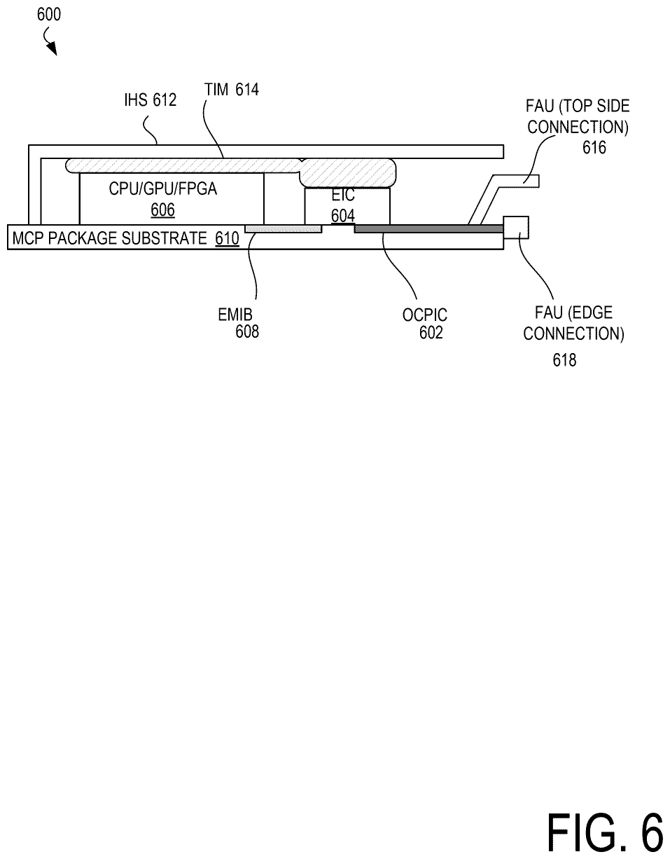

Turning now to FIG. 6, a PIC having the provided structure is implemented as an open cavity PIC (OCPIC) in a semiconductor assembly application, as may be assembled by a system integrator. A multi-die semiconductor assembly can be referred to as a multi-chip package (MCP) or, alternatively, a multi-chip module (MCM). FIG. 6 is a simplified cross-sectional side view of an exemplary multi-chip package (MCP) 600 that includes an OCPIC 602, in accordance with various embodiments. The MCP 600 may comprise one or more processor units, CPUs, graphics processors, or FPGAs, as represented by electronic integrated circuit (EIC) 604, and integrated circuit 606. In addition, the MCP 600 can comprise additional components, such as embedded DRAM, stacked high bandwidth memory (HBM), shared cache memories, input/output (I/O) controllers, or memory controllers. Any of these additional components can be located on the same integrated circuit die as a processor unit, or on one or more integrated circuit dies separate from the integrated circuit dies comprising the processor units. These separate integrated circuit dies can be referred to as “chiplets.”

In some embodiments, the OCPIC 602 chiplet is embedded in a MCP package substrate 610 (and the substrate of the OCPIC substrate is distinguished therefrom as PIC substrate, which may or may not be the same as the MCP package substrate). In other embodiments, the OCPIC 602 chiplet is attached to a MCP package substrate 610. The OCPIC 602 is adjacent to the EIC 604 that is configured specifically to receive and process data from the OCPIC 602. In practice, interconnections between the dies and/or chiplets of MCP 600 can be provided by the MCP package substrate 610, one or more silicon interposers, one or more silicon bridges 708 embedded in the package substrate 610 (such as Intel® embedded multi-die interconnect bridges (EMIBs)), or combinations thereof. Silicon bridge 608 is shown to operationally couple the integrated circuit 606 with the electronic integrated circuit 604.

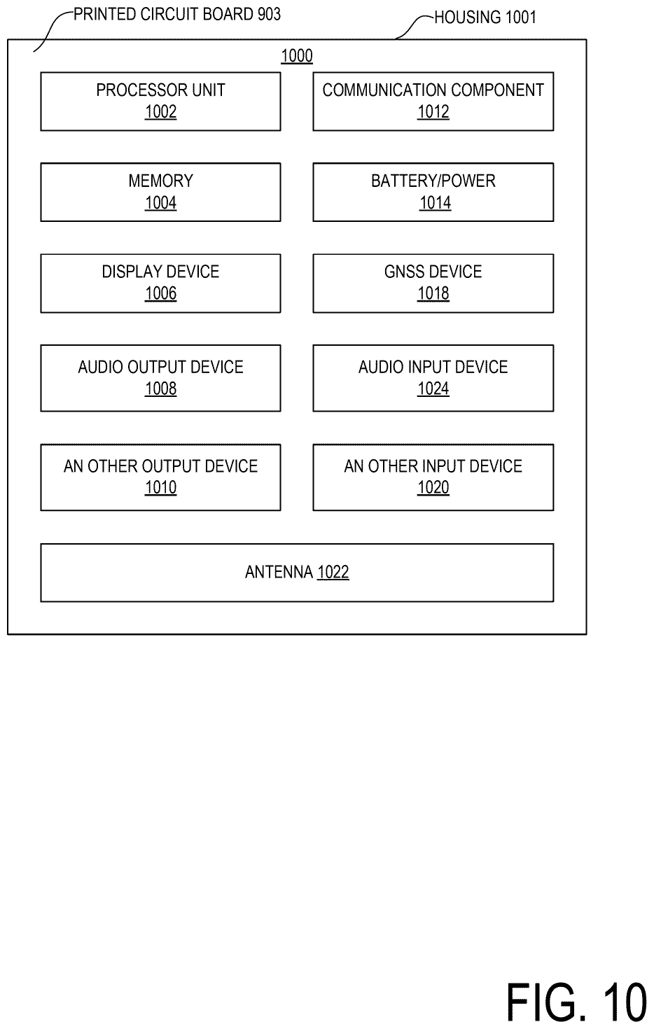

A thermal conduction layer interface material (TIM) 614 may be located over the integrated circuit 606 and the electronic integrated circuit 604. The TIM 614 can be any suitable material, such as a silver-particle filled thermal compound, thermal grease, phase change materials, indium foils or graphite sheets. An integrated heat spreader (IHS) 612, located on the TIM 614, covers the components of the MCP 600. In practice, the MCP 600, and the OCPIC 602 specifically, may communicate with other components in a device (e.g., device 1000, FIG. 10) via a fiber array unit (FAU) connector. In various embodiments, the FAU connector may be a top side connector 616, such as a grating coupler, or an edge connector 618, such as a micro-lens or V-groove.

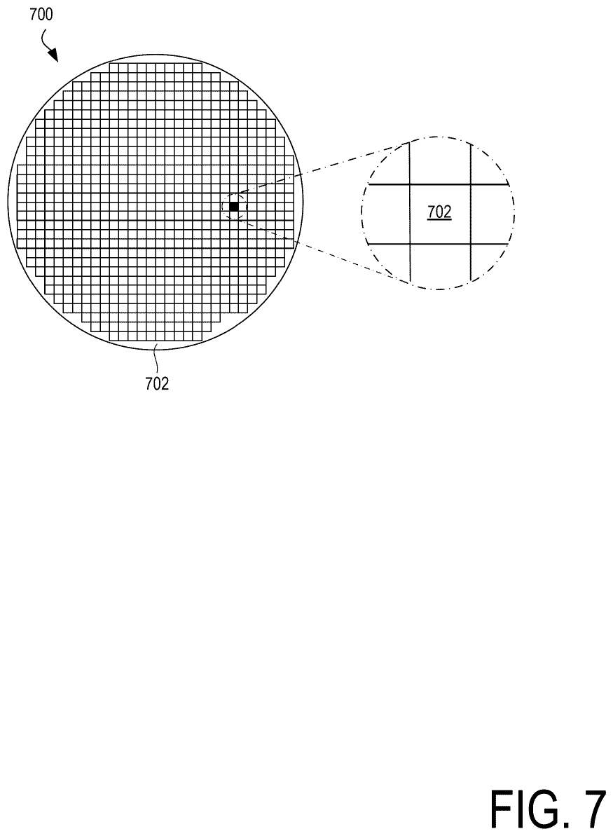

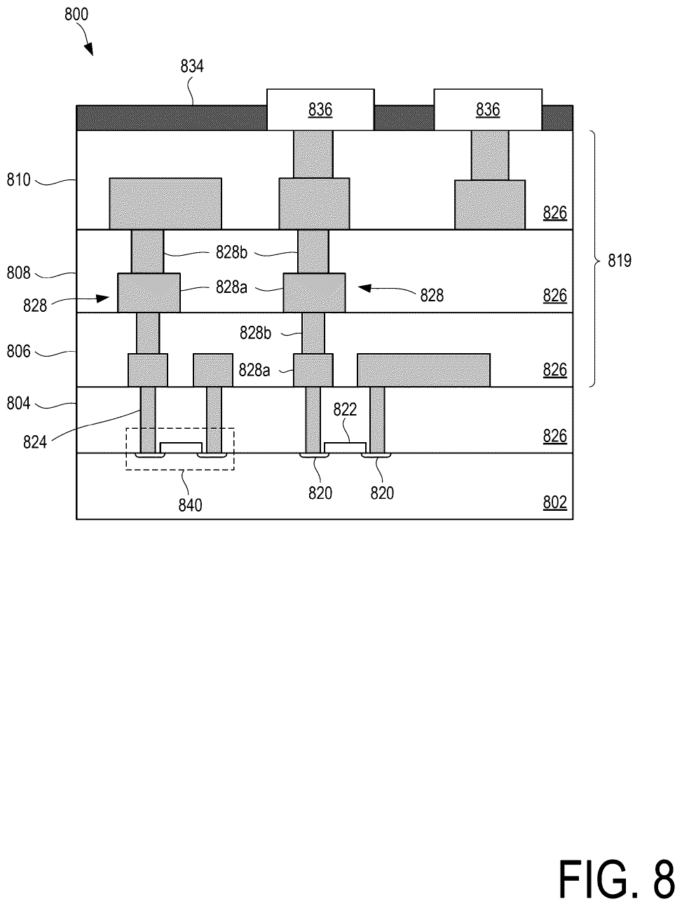

FIG. 7 is a top view of a wafer 700 and dies 702 that may be included in any of the embodiments disclosed herein. The wafer 700 may be composed of semiconductor material and may include one or more dies 702 formed on a surface of the wafer 700. After the fabrication of the integrated circuit components on the wafer 700 is complete, the wafer 700 may undergo a singulation process in which the dies 702 are separated from one another to provide discrete “chips” or destined for a packaged integrated circuit component. The individual dies 702, comprising an integrated circuit component, may include one or more transistors (e.g., some of the transistors 840 of FIG. 8, discussed below), supporting circuitry to route electrical signals to the transistors, passive components (e.g., signal traces, resistors, capacitors, or inductors), and/or any other integrated circuit components. In some embodiments, the wafer 700 or the die 702 may include a memory device (e.g., a random access memory (RAM) device, such as a static RAM (SRAM) device, a magnetic RAM (MRAM) device, a resistive RAM (RRAM) device, a conductive-bridging RAM (CBRAM) device, etc.), a logic device (e.g., an AND, OR, NAND, or NOR gate), or any other suitable circuit element. Additionally, multiple devices may be combined on a single die 702. For example, a memory array formed by multiple memory devices may be formed on a same die 702 as a processor unit (e.g., the processor unit 1002 of FIG. 10) or other logic that is configured to store information in the memory devices or execute instructions stored in the memory array. In some embodiments, a die 702 may be attached to a wafer 700 that includes other die, and the wafer 700 is subsequently singulated, this manufacturing procedure is referred to as a die-to-wafer assembly technique.

FIG. 8 is a cross-sectional side view of an integrated circuit 800 that may be included in any of the embodiments disclosed herein. One or more of the integrated circuits 800 may be included in one or more dies 702 (FIG. 7). The integrated circuit 800 may be formed on a die substrate 802 (e.g., the wafer 700 of FIG. 7) and may be included in a die (e.g., the die 702 of FIG. 7).

The die substrate 802 may be a semiconductor substrate composed of semiconductor material systems including, for example, n-type or p-type materials systems (or a combination of both). The die substrate 802 may include, for example, a crystalline substrate formed using a bulk silicon or a silicon-on-insulator (SOI) substructure. In some embodiments, the die substrate 802 may be formed using alternative materials, which may or may not be combined with silicon, that include, but are not limited to, germanium, indium antimonide, lead telluride, indium arsenide, indium phosphide, gallium arsenide, or gallium antimonide. Further materials classified as group II-VI, III-V. or IV may also be used to form the die substrate 802. Although a few examples of materials from which the die substrate 802 may be formed are described here, any material that may serve as a foundation for an integrated circuit 800 may be used. The die substrate 802 may be part of a singulated die (e.g., the dies 702 of FIG. 7) or a wafer (e.g., the wafer 700 of FIG. 7).

The integrated circuit 800 may include one or more device layers 804 disposed on the die substrate 802. The device layer 804 may include features of one or more transistors 840 (e.g., metal oxide semiconductor field-effect transistors (MOSFETs)) formed on the die substrate 802. The transistors 840 may include, for example, one or more source and/or drain (S/D) regions 820, a gate 822 to control current flow between the S/D regions 820, and one or more S/D contacts 824 to route electrical signals to/from the S/D regions 820.

The gate 822 may be formed of at least two layers, a gate dielectric and a gate electrode. The gate dielectric may include one layer or a stack of layers. The one or more layers may include silicon oxide, silicon dioxide, silicon carbide, and/or a high-k dielectric material. The high-k dielectric material may include elements such as hafnium, silicon, oxygen, titanium, tantalum, lanthanum, aluminum, zirconium, barium, strontium, yttrium, lead, scandium, niobium, and zinc. Examples of high-k materials that may be used in the gate dielectric include, but are not limited to, hafnium oxide, hafnium silicon oxide, lanthanum oxide, lanthanum aluminum oxide, zirconium oxide, zirconium silicon oxide, tantalum oxide, titanium oxide, barium strontium titanium oxide, barium titanium oxide, strontium titanium oxide, yttrium oxide, aluminum oxide, lead scandium tantalum oxide, and lead zinc niobate. In some embodiments, an annealing process may be conducted on the gate dielectric to improve its quality when a high-k material is used.

The gate electrode may be formed on the gate dielectric and may include at least one p-type work function metal or n-type work function metal, depending on whether the transistor 840 is to be a p-type metal oxide semiconductor (PMOS) or an n-type metal oxide semiconductor (NMOS) transistor. In some implementations, the gate electrode may comprise a stack of two or more metal layers, where one or more metal layers are work function metal layers and at least one metal layer is a fill metal layer. Further metal layers may be included for other purposes, such as a barrier layer.

For a PMOS transistor, metals that may be used for the gate electrode include, but are not limited to, ruthenium, palladium, platinum, cobalt, nickel, conductive metal oxides (e.g., ruthenium oxide), and any of the metals discussed below with reference to an NMOS transistor (e.g., for work function tuning). For an NMOS transistor, metals that may be used for the gate electrode include, but are not limited to, hafnium, zirconium, titanium, tantalum, aluminum, alloys of these metals, carbides of these metals (e.g., hafnium carbide, zirconium carbide, titanium carbide, tantalum carbide, and aluminum carbide), and any of the metals discussed above with reference to a PMOS transistor (e.g., for work function tuning).

In some embodiments, when viewed as a cross-section of the transistor 840 along the source-channel-drain direction, the gate electrode may comprise a U-shaped structure that includes a bottom portion substantially parallel to the surface of the die substrate 802 and two sidewall portions that are substantially perpendicular to the top surface of the die substrate 802. In other embodiments, at least one of the metal layers that form the gate electrode may simply be a planar layer that is substantially parallel to the top surface of the die substrate 802 and does not include sidewall portions substantially perpendicular to the top surface of the die substrate 802. In other embodiments, the gate electrode may comprise a combination of U-shaped structures and planar, non-U-shaped structures. For example, the gate electrode may comprise one or more U-shaped metal layers formed atop one or more planar, non-U-shaped layers.

In some embodiments, a pair of sidewall spacers may be formed on opposing sides of the gate stack to bracket the gate stack. The sidewall spacers may be formed from materials such as silicon nitride, silicon oxide, silicon carbide, silicon nitride doped with carbon, and silicon oxynitride. Processes for forming sidewall spacers are well known in the art and generally include deposition and etching process steps. In some embodiments, a plurality of spacer pairs may be used; for instance, two pairs, three pairs, or four pairs of sidewall spacers may be formed on opposing sides of the gate stack.

The S/D regions 820 may be formed within the die substrate 802 adjacent to the gate 822 of individual transistors 840. The S/D regions 820 may be formed using an implantation/diffusion process or an etching/deposition process, for example. In the former process, dopants such as boron, aluminum, antimony, phosphorous, or arsenic may be ion-implanted into the die substrate 802 to form the S/D regions 820. An annealing process that activates the dopants and causes them to diffuse farther into the die substrate 802 may follow the ion-implantation process. In the latter process, the die substrate 802 may first be etched to form recesses at the locations of the S/D regions 820. An epitaxial deposition process may then be conducted to fill the recesses with material that is used to fabricate the S/D regions 820. In some implementations, the S/D regions 820 may be fabricated using a silicon alloy such as silicon germanium or silicon carbide. In some embodiments, the epitaxially deposited silicon alloy may be doped in situ with dopants such as boron, arsenic, or phosphorous. In some embodiments, the S/D regions 820 may be formed using one or more alternate semiconductor materials such as germanium or a group III-V material or alloy. In further embodiments, one or more layers of metal and/or metal alloys may be used to form the S/D regions 820.

Electrical signals, such as power and/or input/output (I/O) signals, may be routed to and/or from the devices (e.g., transistors 840) of the device layer 804 through one or more interconnect layers disposed on the device layer 804 (illustrated in FIG. 8 as interconnect layers 806-810). For example, electrically conductive features of the device layer 804 (e.g., the gate 822 and the S/D contacts 824) may be electrically coupled with the interconnect structures 828 of the interconnect layers 806-810. The one or more interconnect layers 806-810 may form a metallization stack (also referred to as an “ILD stack”) 819 of the integrated circuit 800.

The interconnect structures 828 may be arranged within the interconnect layers 806-810 to route electrical signals according to a wide variety of designs; in particular, the arrangement is not limited to the particular configuration of interconnect structures 828 depicted in FIG. 8. Although a particular number of interconnect layers 806-810 is depicted in FIG. 8, embodiments of the present disclosure include integrated circuits having more or fewer interconnect layers than depicted.

In some embodiments, the interconnect structures 828 may include lines 828a and/or vias 828b filled with an electrically conductive material such as a metal. The lines 828a may be arranged to route electrical signals in a direction of a plane that is substantially parallel with a surface of the die substrate 802 upon which the device layer 804 is formed. For example, the lines 828a may route electrical signals in a direction in and out of the page and/or in a direction across the page. The vias 828b may be arranged to route electrical signals in a direction of a plane that is substantially perpendicular to the surface of the die substrate 802 upon which the device layer 804 is formed. In some embodiments, the vias 828b may electrically couple lines 828a of different interconnect layers 806-810 together.

The interconnect layers 806-810 may include a dielectric material 826 disposed between the interconnect structures 828, as shown in FIG. 8. In some embodiments, dielectric material 826 disposed between the interconnect structures 828 in different ones of the interconnect layers 806-810 may have different compositions; in other embodiments, the composition of the dielectric material 826 between different interconnect layers 806-810 may be the same. The device layer 804 may include a dielectric material 826 disposed between the transistors 840 and a bottom layer of the metallization stack as well. The dielectric material 826 included in the device layer 804 may have a different composition than the dielectric material 826 included in the interconnect layers 806-810; in other embodiments, the composition of the dielectric material 826 in the device layer 804 may be the same as a dielectric material 826 included in any one of the interconnect layers 806-810.

A first interconnect layer 806 (referred to as Metal 1 or “M1”) may be formed directly on the device layer 804. In some embodiments, the first interconnect layer 806 may include lines 828a and/or vias 828b, as shown. The lines 828a of the first interconnect layer 806 may be coupled with contacts (e.g., the S/D contacts 824) of the device layer 804. The vias 828b of the first interconnect layer 806 may be coupled with the lines 828a of a second interconnect layer 808.

The second interconnect layer 808 (referred to as Metal 2 or “M2”) may be formed directly on the first interconnect layer 806. In some embodiments, the second interconnect layer 808 may include via 828b to couple the lines 828 of the second interconnect layer 808 with the lines 828a of a third interconnect layer 810. Although the lines 828a and the vias 828b are structurally delineated with a line within individual interconnect layers for the sake of clarity, the lines 828a and the vias 828b may be structurally and/or materially contiguous (e.g., simultaneously filled during a dual-damascene process) in some embodiments.

The third interconnect layer 810 (referred to as Metal 3 or “M3”) (and additional interconnect layers, as desired) may be formed in succession on the second interconnect layer 808 according to similar techniques and configurations described in connection with the second interconnect layer 808 or the first interconnect layer 806. In some embodiments, the interconnect layers that are “higher up” in the metallization stack 819 in the integrated circuit 800 (i.e., farther away from the device layer 804) may be thicker that the interconnect layers that are lower in the metallization stack 819, with lines 828a and vias 828b in the higher interconnect layers being thicker than those in the lower interconnect layers.

The integrated circuit 800 may include a solder resist material 834 (e.g., polyimide or similar material) and one or more conductive contacts 836 formed on the interconnect layers 806-810. In FIG. 8, the conductive contacts 836 are illustrated as taking the form of bond pads. The conductive contacts 836 may be electrically coupled with the interconnect structures 828 and configured to route the electrical signals of the transistor(s) 840 to external devices. For example, solder bonds may be formed on the one or more conductive contacts 836 to mechanically and/or electrically couple an integrated circuit die including the integrated circuit 800 with another component (e.g., a printed circuit board). The integrated circuit 800 may include additional or alternate structures to route the electrical signals from the interconnect layers 806-810; for example, the conductive contacts 836 may include other analogous features (e.g., posts) that route the electrical signals to external components.

In some embodiments in which the integrated circuit 800 is a double-sided die, the integrated circuit 800 may include another metallization stack (not shown) on the opposite side of the device layer(s) 804. This metallization stack may include multiple interconnect layers as discussed above with reference to the interconnect layers 806-810, to provide conductive pathways (e.g., including conductive lines and vias) between the device layer(s) 804 and additional conductive contacts (not shown) on the opposite side of the integrated circuit 800 from the conductive contacts 836.

In other embodiments in which the integrated circuit 800 is a double-sided die, the integrated circuit 800 may include one or more through silicon vias (TSVs) through the die substrate 802; these TSVs may make contact with the device layer(s) 804, and may provide conductive pathways between the device layer(s) 804 and additional conductive contacts (not shown) on the opposite side of the integrated circuit 800 from the conductive contacts 836. In some embodiments, TSVs extending through the substrate can be used for routing power and ground signals from conductive contacts on the opposite side of the integrated circuit 800 from the conductive contacts 836 to the transistors 840 and any other components integrated into the die 800, and the metallization stack 819 can be used to route I/O signals from the conductive contacts 836 to transistors 840 and any other components integrated into the die 800.

Multiple integrated circuits 800 may be stacked with one or more TSVs in the individual stacked devices providing connection between one of the devices to any of the other devices in the stack. For example, one or more high-bandwidth memory (HBM) integrated circuit dies can be stacked on top of a base integrated circuit die and TSVs in the HBM dies can provide connection between the individual HBM and the base integrated circuit die. Conductive contacts can provide additional connections between adjacent integrated circuit dies in the stack. In some embodiments, the conductive contacts can be fine-pitch solder bumps (microbumps).

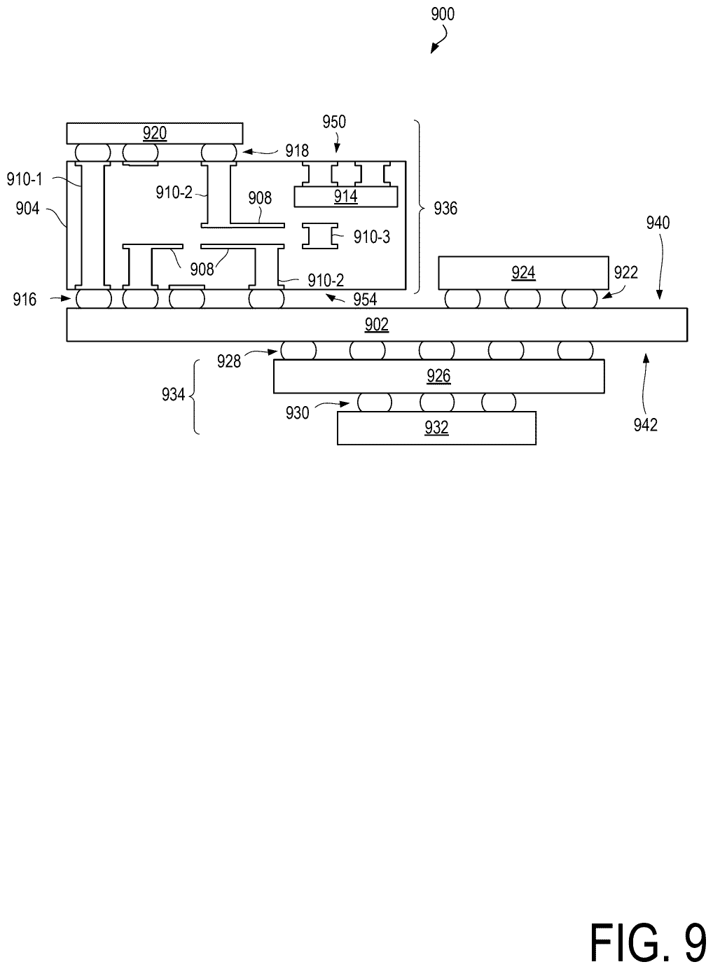

FIG. 9 is a cross-sectional side view of a microelectronic assembly 900 that may include any of the embodiments disclosed herein. The microelectronic assembly 900 includes multiple integrated circuit components disposed on a circuit board 902 (which may be a motherboard, system board, mainboard, etc.). The microelectronic assembly 900 may include components disposed on a first face 940 of the circuit board 902 and an opposing second face 942 of the circuit board 902; generally, components may be disposed on one or both faces 940 and 942.

In some embodiments, the circuit board 902 may be a printed circuit board (PCB) including multiple metal (or interconnect) layers separated from one another by layers of dielectric material and interconnected by electrically conductive vias. The individual metal layers comprise conductive traces. Any one or more of the metal layers may be formed in a desired circuit pattern to route electrical signals (optionally in conjunction with other metal layers) between the components coupled to the circuit board 902. In other embodiments, the circuit board 902 may be a non-PCB substrate. The microelectronic assembly 900 illustrated in FIG. 9 includes a package-on-interposer structure 936 coupled to the first face 940 of the circuit board 902 by coupling components 916. The coupling components 916 may electrically and mechanically couple the package-on-interposer structure 936 to the circuit board 902, and may include solder balls (as shown in FIG. 9), pins (e.g., as part of a pin grid array (PGA), contacts (e.g., as part of a land grid array (LGA)), male and female portions of a socket, an adhesive, an underfill material, and/or any other suitable electrical and/or mechanical coupling structure.

The package-on-interposer structure 936 may include an integrated circuit component 920 coupled to an interposer 904 by coupling components 918. The coupling components 918 may take any suitable form for the application, such as the forms discussed above with reference to the coupling components 916. Although a single integrated circuit component 920 is shown in FIG. 9, multiple integrated circuit components may be coupled to the interposer 904; indeed, additional interposers may be coupled to the interposer 904. The interposer 904 may provide an intervening substrate used to bridge the circuit board 902 and the integrated circuit component 920.

The integrated circuit component 920 may be a packaged or unpackaged integrated circuit component that includes one or more integrated circuit dies (e.g., the die 702 of FIG. 7, the integrated circuit 800 of FIG. 8) and/or one or more other suitable components.

The unpackaged integrated circuit component 920 comprises solder bumps attached to contacts on the die. The solder bumps allow the die to be directly attached to the interposer 904. In embodiments where the integrated circuit component 920 comprises multiple integrated circuit dies, the dies can be of the same type (a homogeneous multi-die integrated circuit component) or of two or more different types (a heterogeneous multi-die integrated circuit component). In addition to comprising one or more processor units, the integrated circuit component 920 can comprise additional components, such as embedded DRAM, stacked high bandwidth memory (HBM), shared cache memories, input/output (I/O) controllers, or memory controllers. Any of these additional components can be located on the same integrated circuit die as a processor unit, or on one or more integrated circuit dies separate from the integrated circuit dies comprising the processor units. These separate integrated circuit dies can be referred to as “chiplets”. In embodiments where an integrated circuit component comprises multiple integrated circuit dies, interconnections between dies can be provided by the package substrate, one or more silicon interposers, one or more silicon bridges embedded in the package substrate (such as Intel® embedded multi-die interconnect bridges (EMIBs)), or combinations thereof. A packaged multi-die integrated circuit component can be referred to as a multi-chip package (MCP) or multi-chip module (MCM).

Generally, the interposer 904 may spread connections to a wider pitch or reroute a connection to a different connection. For example, the interposer 904 may couple the integrated circuit component 920 to a set of ball grid array (BGA) conductive contacts of the coupling components 916 for coupling to the circuit board 902. In the embodiment illustrated in FIG. 9, the integrated circuit component 920 and the circuit board 902 are attached to opposing sides of the interposer 904; in other embodiments, the integrated circuit component 920 and the circuit board 902 may be attached to a same side of the interposer 904. In some embodiments, three or more components may be interconnected by way of the interposer 904.

In some embodiments, the interposer 904 may be formed as a PCB, including multiple metal layers separated from one another by layers of dielectric material and interconnected by electrically conductive vias. In some embodiments, the interposer 904 may be formed of an epoxy resin, a fiberglass-reinforced epoxy resin, an epoxy resin with inorganic fillers, a ceramic material, or a polymer material such as polyimide. In some embodiments, the interposer 904 may be formed of alternate rigid or flexible materials that may include the same materials described above for use in a semiconductor substrate, such as silicon, germanium, and other group III-V and group IV materials. The interposer 904 may include metal interconnects 908 and vias 910, including but not limited to through hole vias 910-1 (that extend from a first face 950 of the interposer 904 to a second face 954 of the interposer 904), blind vias 910-2 (that extend from the first or second faces 950 or 954 of the interposer 904 to an internal metal layer), and buried vias 910-3 (that connect internal metal layers).

In some embodiments, the interposer 904 can comprise a silicon interposer. Through silicon vias (TSV) extending through the silicon interposer can connect connections on the first face of a silicon interposer to an opposing second face of the silicon interposer. In some embodiments, an interposer 904 comprising a silicon interposer can further comprise one or more routing layers to route connections on a first face of the interposer 904 to an opposing second face of the interposer 904.

The interposer 904 may further include embedded devices 914, including both passive and active devices. Such devices may include, but are not limited to, capacitors, decoupling capacitors, resistors, inductors, fuses, diodes, transformers, sensors, electrostatic discharge (ESD) devices, and memory devices. More complex devices such as radio frequency devices, power amplifiers, power management devices, antennas, arrays, sensors, and microelectromechanical systems (MEMS) devices may also be formed on the interposer 904. The package-on-interposer structure 936 may take the form of any of the package-on-interposer structures known in the art. In embodiments where the interposer is a non-printed circuit board

The integrated circuit assembly 900 may include an integrated circuit component 924 coupled to the first face 940 of the circuit board 902 by coupling components 922. The coupling components 922 may take the form of any of the embodiments discussed above with reference to the coupling components 916, and the integrated circuit component 924 may take the form of any of the embodiments discussed above with reference to the integrated circuit component 920.

The integrated circuit assembly 900 illustrated in FIG. 9 includes a package-on-package structure 934 coupled to the second face 942 of the circuit board 902 by coupling components 928. The package-on-package structure 934 may include an integrated circuit component 926 and an integrated circuit component 932 coupled together by coupling components 930 such that the integrated circuit component 926 is disposed between the circuit board 902 and the integrated circuit component 932. The coupling components 928 and 930 may take the form of any of the embodiments of the coupling components 916 discussed above, and the integrated circuit components 926 and 932 may take the form of any of the embodiments of the integrated circuit component 920 discussed above. The package-on-package structure 934 may be configured in accordance with any of the package-on-package structures known in the art.

FIG. 10 is a block diagram of an example electrical device 1000 that may include one or more of the embodiments disclosed herein. For example, any suitable ones of the components of the electrical device 1000 may include one or more of the microelectronic assemblies 900, integrated circuit components 920, integrated circuits 800, integrated circuit dies 702, or structures disclosed herein. A number of components are illustrated in FIG. 10 as included in the electrical device 1000, but any one or more of these components may be omitted or duplicated, as suitable for the application. In some embodiments, some or all of the components included in the electrical device 1000 may be attached to one or more motherboards, mainboards, printed circuit boards 903, or system boards. In some embodiments, one or more of these components are fabricated onto a single system-on-a-chip (SoC) die. In various embodiments, the electrical device 900 is enclosed by, or integrated with, a housing 901.

Additionally, in various embodiments, the electrical device 1000 may not include one or more of the components illustrated in FIG. 10, but the electrical device 1000 may include interface circuitry for coupling to the one or more components. For example, the electrical device 1000 may not include a display device 1006, but may include display device interface circuitry (e.g., a connector and driver circuitry) to which a display device 1006 may be coupled. In another set of examples, the electrical device 1000 may not include an audio input device 1024 or an audio output device 1008, but may include audio input or output device interface circuitry (e.g., connectors and supporting circuitry) to which an audio input device 1024 or audio output device 1008 may be coupled.

The electrical device 1000 may include one or more processor units 1002 (e.g., one or more processor units). As used herein, the terms “processor unit”, “processing unit” or “processor” may refer to any device or portion of a device that processes electronic data from registers and/or memory to transform that electronic data into other electronic data that may be stored in registers and/or memory. The processor unit 1002 may include one or more digital signal processors (DSPs), application-specific integrated circuits (ASICs), central processing units (CPUs), graphics processing units (GPUs), general-purpose GPUs (GPGPUs), accelerated processing units (APUs), field-programmable gate arrays (FPGAs), neural network processing units (NPUs), data processor units (DPUs), accelerators (e.g., graphics accelerator, compression accelerator, artificial intelligence accelerator), controller crypto processors (specialized processors that execute cryptographic algorithms within hardware), server processors, controllers, or any other suitable type of processor units. As such, the processor unit can be referred to as an XPU (or xPU).

The electrical device 1000 may include a memory 1004, which may itself include one or more memory devices such as volatile memory (e.g., dynamic random access memory (DRAM), static random-access memory (SRAM)), non-volatile memory (e.g., read-only memory (ROM), flash memory, chalcogenide-based phase-change non-voltage memories), solid state memory, and/or a hard drive. In some embodiments, the memory 1004 may include memory that is located on the same integrated circuit die as the processor unit 1002. This memory may be used as cache memory (e.g., Level 1 (L1), Level 2 (L2), Level 3 (L3), Level 4 (L4), Last Level Cache (LLC)) and may include embedded dynamic random-access memory (eDRAM) or spin transfer torque magnetic random-access memory (STT-MRAM).

In some embodiments, the electrical device 1000 can comprise one or more processor units 1002 that are heterogeneous or asymmetric to another processor unit 1002 in the electrical device 1000. There can be a variety of differences between the processing units 1002 in a system in terms of a spectrum of metrics of merit including architectural, microarchitectural, thermal, power consumption characteristics, and the like. These differences can effectively manifest themselves as asymmetry and heterogeneity among the processor units 1002 in the electrical device 1000.

In some embodiments, the electrical device 1000 may include a communication component 1012 (e.g., one or more communication components). For example, the communication component 1012 can manage wireless communications for the transfer of data to and from the electrical device 1000. The term “wireless” and its derivatives may be used to describe circuits, devices, systems, methods, techniques, communications channels, etc., that may communicate data through the use of modulated electromagnetic radiation through a nonsolid medium. The term “wireless” does not imply that the associated devices do not contain any wires, although in some embodiments they might not.

The communication component 1012 may implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), Long-Term Evolution (LTE) project along with any amendments, updates, and/or revisions (e.g., advanced LTE project, ultra-mobile broadband (UMB) project (also referred to as “3GPP2”), etc.). IEEE 802.16 compatible Broadband Wireless Access (BWA) networks are generally referred to as WiMAX networks, an acronym that stands for Worldwide Interoperability for Microwave Access, which is a certification mark for products that pass conformity and interoperability tests for the IEEE 802.16 standards. The communication component 1012 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication component 1012 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication component 1012 may operate in accordance with Code Division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication component 1012 may operate in accordance with other wireless protocols in other embodiments. The electrical device 1000 may include an antenna 1022 to facilitate wireless communications and/or to receive other wireless communications (such as AM or FM radio transmissions).

In some embodiments, the communication component 1012 may manage wired communications, such as electrical, optical, or any other suitable communication protocols (e.g., IEEE 802.3 Ethernet standards). As noted above, the communication component 1012 may include multiple communication components. For instance, a first communication component 1012 may be dedicated to shorter-range wireless communications such as Wi-Fi or Bluetooth, and a second communication component 1012 may be dedicated to longer-range wireless communications such as global positioning system (GPS), EDGE, GPRS, CDMA, WiMAX, LTE, EV-DO, or others. In some embodiments, a first communication component 1012 may be dedicated to wireless communications, and a second communication component 1012 may be dedicated to wired communications.

The electrical device 1000 may include battery/power circuitry 1014. The battery/power circuitry 1014 may include one or more energy storage devices (e.g., batteries or capacitors) and/or circuitry for coupling components of the electrical device 1000 to an energy source separate from the electrical device 1000 (e.g., AC line power).

The electrical device 1000 may include a display device 1006 (or corresponding interface circuitry, as discussed above). The display device 1006 may include one or more embedded or wired or wirelessly connected external visual indicators, such as a heads-up display, a computer monitor, a projector, a touchscreen display, a liquid crystal display (LCD), a light-emitting diode display, or a flat panel display.

The electrical device 1000 may include an audio output device 1008 (or corresponding interface circuitry, as discussed above). The audio output device 1008 may include any embedded or wired or wirelessly connected external device that generates an audible indicator, such speakers, headsets, or earbuds.

The electrical device 1000 may include an audio input device 1024 (or corresponding interface circuitry, as discussed above). The audio input device 1024 may include any embedded or wired or wirelessly connected device that generates a signal representative of a sound, such as microphones, microphone arrays, or digital instruments (e.g., instruments having a musical instrument digital interface (MIDI) output). The electrical device 1000 may include a Global Navigation Satellite System (GNSS) device 1018 (or corresponding interface circuitry, as discussed above), such as a Global Positioning System (GPS) device. The GNSS device 1018 may be in communication with a satellite-based system and may determine a geolocation of the electrical device 1000 based on information received from one or more GNSS satellites, as known in the art.

The electrical device 1000 may include another output device 1010 (or corresponding interface circuitry, as discussed above). Examples of the other output device 1010 may include an audio codec, a video codec, a printer, a wired or wireless transmitter for providing information to other devices, or an additional storage device.

The electrical device 1000 may include another input device 1020 (or corresponding interface circuitry, as discussed above). Examples of the other input device 1020 may include an accelerometer, a gyroscope, a compass, an image capture device (e.g., monoscopic or stereoscopic camera), a trackball, a trackpad, a touchpad, a keyboard, a cursor control device such as a mouse, a stylus, a touchscreen, proximity sensor, microphone, a bar code reader, a Quick Response (QR) code reader, electrocardiogram (ECG) sensor, PPG (photoplethysmogram) sensor, galvanic skin response sensor, any other sensor, or a radio frequency identification (RFID) reader.

The electrical device 1000 may have any desired form factor, such as a hand-held or mobile electrical device (e.g., a cell phone, a smart phone, a mobile internet device, a music player, a tablet computer, a laptop computer, a 2-in-1 convertible computer, a portable all-in-one computer, a netbook computer, an ultrabook computer, a personal digital assistant (PDA), an ultra-mobile personal computer, a portable gaming console, etc.), a desktop electrical device, a server, a rack-level computing solution (e.g., blade, tray or sled computing systems), a workstation or other networked computing component, a printer, a scanner, a monitor, a set-top box, an entertainment control unit, a stationary gaming console, smart television, a vehicle control unit, a digital camera, a digital video recorder, a wearable electrical device or an embedded computing system (e.g., computing systems that are part of a vehicle, smart home appliance, consumer electronics product or equipment, manufacturing equipment). In some embodiments, the electrical device 1000 may be any other electronic device that processes data. In some embodiments, the electrical device 1000 may comprise multiple discrete physical components. Given the range of devices that the electrical device 1000 can be manifested as in various embodiments, in some embodiments, the electrical device 1000 can be referred to as a computing device or a computing system.

Thus, embodiments of a structure for an open-cavity photonic integrated circuit (OCPIC) having a micro-ring resonator (MRR) have been provided. The provided embodiments advantageously enhance power efficiency of the MRR and the OCPIC. Embodiments enable the use of finer pitch architectures and high-density input/output (I/O) designs without impacting thermal efficiency.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. Various changes can be made in the function and arrangement of elements without departing from the scope of the disclosure as set forth in the appended claims and the legal equivalents thereof.

As used herein, phrases such as “an embodiment,” “various embodiments,” “some embodiments,” and the like, indicate that some embodiments may have some, all, or none of the features described for other embodiments. “First,” “second,” “third,” and the like describe a common object and indicate different instances of like objects being referred to; unless specifically stated, they do not imply a given sequence, either temporally or spatially, in ranking, or any other manner. In accordance with patent application parlance, “connected” indicates elements that are in direct physical or electrical contact with each other and “coupled” indicates elements that co-operate or interact with each other, coupled elements may or may not be in direct physical or electrical contact. Furthermore, the terms “comprising,” “including,” “having,” and the like, are utilized synonymously to denote non-exclusive inclusions.

As used in this application and the claims, a list of items joined by the term “at least one of” or the term “one or more of” can mean any combination of the listed terms. For example, the phrase “at least one of A, B or C” can mean A; B; C; A and B; A and C; B and C; or A, B, and C. Likewise, the phrase “one or more of A, B and C” can mean A; B; C; A and B; A and C; B and C; or A, B, and C.

As used in this application and the claims, the phrase “individual of” or “respective of” following by a list of items recited or stated as having a trait, feature, etc. means that all of the items in the list possess the stated or recited trait, feature, etc. For example, the phrase “individual of A, B, or C, comprise a sidewall” or “respective of A, B, or C, comprise a sidewall” means that A comprises a sidewall, B comprises sidewall, and C comprises a sidewall.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

### EXAMPLES

Example 1 is an apparatus comprising: a photonic integrated circuit (PIC) die comprising: a main waveguide that extends parallel to a top surface of the PIC die; and an auxiliary waveguide located alongside the main waveguide, the auxiliary waveguide to couple light from the main waveguide to a photodiode; and a scattering structure located on the auxiliary waveguide away from the photodiode, the scattering structure is to deflect light from the auxiliary waveguide through the top surface or through a bottom surface of the PIC die.

Example 2 includes the subject matter of Example 1, wherein the scattering structure comprises a diffraction grating, and the scattering structure, the main waveguide and the auxiliary waveguide are coplanar and substantially parallel to the top surface.

Example 3 includes the subject matter of Example 1, wherein the scattering structure comprises a plurality of cavities in a portion of the auxiliary waveguide, the plurality of cavities extending perpendicularly inward from a periphery of the auxiliary waveguide.

Example 4 includes the subject matter of Example 1, wherein the scattering structure comprises a bend in the auxiliary waveguide of about 90 degrees, or a spiral in the auxiliary waveguide, or a zig zag in the auxiliary waveguide.

Example 5 includes the subject matter of Example 1, wherein the scattering structure comprises a v-groove extending from the top surface into the PIC die, the v-groove oriented substantially perpendicular to the auxiliary waveguide.

Example 6 includes the subject matter of any one of Examples 1-5, further comprising a mirror oriented to reflect the deflected light from the scattering structure out of the PIC die.

Example 7 includes the subject matter of Example 6 wherein the mirror is located on the bottom surface of the PIC die to reflect light from the scattering structure out of the top surface of the PIC die.

Example 8 includes the subject matter of Example 6, further comprising: a substrate layer located on a bottom surface of the PIC die; and the mirror is located on the top surface of the PIC die to reflect the deflected light from the scattering structure out of the bottom surface of the PIC die and through the substrate layer.

Example 9 includes the subject matter of any one of Examples 7 or 8, wherein the mirror comprises a metallic layer oriented to be parallel with the top surface of the PIC die.

Example 10 includes the subject matter of any one of Examples 6-9, wherein the mirror comprises aluminum or silver.

Example 11 includes the subject matter of any one of Examples 1-10, wherein the main waveguide is a first main waveguide; the auxiliary waveguide is a first auxiliary waveguide, and the scattering structure is a first scattering structure, and further comprising: a second main waveguide; a second auxiliary waveguide located alongside the second main waveguide, the second auxiliary waveguide is to couple light in the second main waveguide to a second photodiode; and a second scattering structure located on the second auxiliary waveguide, away from the second photodiode, the second scattering structure is to reflect light from the second auxiliary waveguide through the top surface or through the bottom surface of the PIC die.

Example 12 is an apparatus comprising: a photonic integrated circuit (PIC) die comprising: one or more main waveguides that extend parallel to a top surface of the PIC die; an auxiliary waveguide located substantially parallel to one of the one or more main waveguides, the auxiliary waveguide to couple light from the main waveguide to a photodiode in the PIC die; and means for scattering light to deflect light from the auxiliary waveguide through the top surface or through a bottom surface of the PIC die.

Example 13 includes the subject matter of Example 12, further comprising: a means for reflecting light; and wherein the means for reflecting light and the means for scattering light are oriented to deflect light through the top surface or through the bottom surface.

Example 14 includes the subject matter of Example 12, further comprising: a means for reflecting light; and a substrate layer located on the bottom surface of the PIC die; and wherein the means for reflecting light and the means for scattering light are further oriented to deflect light through the substrate layer.

Example 15 includes the subject matter of any one of Examples 12-14, wherein the means for scattering light from the auxiliary waveguide comprises a diffraction grating.

Example 16 includes the subject matter of any one of Examples 12-15, wherein the means for reflecting light comprises a reflective surface oriented in parallel to the top surface.

Example 17 includes the subject matter of any one of Examples 12-14, wherein the means for reflecting light comprises a reflective surface disposed in a cavity extending from the top surface.

Example 18 is a method comprising: forming a scattering structure at an unconnected terminus of an auxiliary waveguide in a photonic integrated circuit (PIC) die using selective laser etching, wherein the auxiliary waveguide is one of one or more auxiliary waveguides, the one or more auxiliary waveguides to couple light from a respective one or more main waveguides in the PIC die to respective photodiodes; forming a mirror on a first surface of the PIC die; and overlaying a substrate layer on an opposite surface of the PIC die, wherein the mirror and the scattering structure are to reflect light through the substrate layer.

Example 19 includes the subject matter of Example 18, further comprising forming the scattering structure as a plurality of cavities extending into the auxiliary waveguide.

Example 20 includes the subject matter of Example 18, further comprising forming the scattering structure as a v-groove extending from an upper surface of the PIC die to intersect the auxiliary waveguide at a substantially perpendicular angle.

What is claimed is:

1. A photonic integrated circuit (PIC) die comprising:
a main waveguide that extends within a top surface of the PIC die;
an auxiliary waveguide located alongside the main waveguide, the auxiliary waveguide to couple light from the main waveguide to a photodiode; and
the auxiliary waveguide having thereon a scattering structure located away from the photodiode, the scattering structure is to deflect light from the auxiliary waveguide through the top surface or through a bottom surface of the PIC die.

2. The PIC die of claim 1, wherein the scattering structure comprises a diffraction grating.

3. The PIC die of claim 1, wherein the scattering structure comprises a plurality of cavities in the auxiliary waveguide, the plurality of cavities extending perpendicularly inward from a periphery of the auxiliary waveguide.

4. The PIC die of claim 1, wherein the scattering structure comprises a bend in the auxiliary waveguide of about 90 degrees, or a spiral in the auxiliary waveguide, or a zig zag in the auxiliary waveguide.

5. The PIC die of claim 1, wherein the scattering structure comprises surfaces defining a v-groove in the PIC die, the v-groove oriented substantially perpendicular to a lateral axis of the auxiliary waveguide.

6. The PIC die of claim 1, further comprising a mirror layer oriented to reflect the deflected light from the scattering structure out of the PIC die.

7. The PIC die of claim 6 wherein the mirror layer is located on the bottom surface of the PIC die to reflect light from the scattering structure out of the top surface of the PIC die.

8. The PIC die of claim 6, further comprising:
a substrate layer located on the bottom surface of the PIC die; and
the mirror layer is located on the top surface of the PIC die to reflect the deflected light from the scattering structure out of the bottom surface of the PIC die and through the substrate layer.

9. The PIC die of claim 6, wherein the mirror layer comprises a metallic layer oriented to be parallel with the top surface of the PIC die.

10. The PIC die of claim 6, wherein the mirror layer comprises aluminum or silver.

11. The PIC die of claim 1, wherein the main waveguide is a first main waveguide; the auxiliary waveguide is a first auxiliary waveguide, and the scattering structure is a first scattering structure, and further comprising:
a second main waveguide;
a second auxiliary waveguide located alongside the second main waveguide, the second auxiliary waveguide is to couple light from the second main waveguide to a second photodiode; and
a second scattering structure located on the second auxiliary waveguide, away from the second photodiode, the second scattering structure is to reflect light from the second auxiliary waveguide through the top surface or through the bottom surface of the PIC die.

12. A semiconductor assembly comprising:
a package substrate;
a photonic integrated circuit (PIC) on the package substrate, the PIC including:
one or more main waveguides that extend along a top surface of the PIC die;
an auxiliary waveguide located alongside one of the one or more main waveguides, the auxiliary waveguide to couple light from the main waveguide to a photodiode in the PIC die; and
means for scattering light to deflect light from the auxiliary waveguide through the top surface or through a bottom surface of the PIC die; and
an electronic integrated circuit (EIC) component on the package substrate, the EIC component having electrically conductive structures to provide signal communication between the EIC and at least one of the PIC and the package substrate.

13. The semiconductor assembly of claim 12, further comprising:
a means for reflecting light oriented to deflect light through the top surface or through the bottom surface.

14. The semiconductor assembly of claim 12, further comprising:
a substrate layer located on the bottom surface of the PIC die; and
a means for reflecting light oriented to deflect light through the substrate layer.

15. The semiconductor assembly of claim 13, wherein the means for scattering light from the auxiliary waveguide comprises a diffraction grating.

16. The semiconductor assembly of claim 13, wherein the means for reflecting light comprises a reflective surface oriented substantially in parallel with the top surface.

17. The semiconductor assembly of claim 13, wherein the means for reflecting light comprises a reflective surface disposed in a cavity extending from the top surface.

18. A method comprising:
forming a scattering structure at an unconnected terminus of an auxiliary waveguide in a photonic integrated circuit (PIC) die using selective laser etching, wherein the auxiliary waveguide is one of one or more auxiliary waveguides, the one or more auxiliary waveguides to couple light from a respective one or more main waveguides in the PIC die to respective photodiodes;
forming a mirror layer on a first surface of the PIC die; and
overlaying a substrate layer on an opposite surface of the PIC die,
wherein the mirror layer and the scattering structure are to reflect light through the substrate layer.

19. The method of claim 18, further comprising forming the scattering structure as a plurality of cavities extending into the auxiliary waveguide.

20. The method of claim 18, further comprising forming the scattering structure as a v-groove extending from an upper surface of the PIC die to intersect the auxiliary waveguide at a substantially perpendicular angle.
